(19) United States
(12) Patent Application Publication
(10) Pub. No.: US 2008/0015069 A1
(43) Pub. Date: Jan. 17, 2008

(54) Hydraulic Tensioner

(75) Inventors: Bert Kroon, Erlangen (DE); Reinhard Koch, Wachenroth (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/576,632

(22) PCT Filed: Sep. 3, 2005
(86) PCT No.: PCT/EP05/09506

§ 371 Date: May 21, 2007

(30) Foreign Application Priority Data
Oct. 5, 2004 (DE) 102004048281.0

(51) Int. Cl. F16H 7/08

(52) U.S. Cl. 474/110

(57) ABSTRACT

A hydraulic tensioner for traction means, especially of internal combustion engines is provided, and includes a tensioner piston, in the bottom of which an externally opening pressure relief valve is disposed in an axial central bore. The central bore is provided with a hole and is secured with a pot-shaped cap which rests against the piston bottom and is frictionally engaged therewith. In order to make the hydraulic tensioner inexpensive to produce and easy to handle, the pot-shaped cap is provided as a thin-walled sleeve (27) having a bottom (32) while being connected to the outer circumference of a reduced end (31) of the piston bottom (19), preferably by a press fit. Furthermore, the hole (34) is located in the bottom (32) of the sleeve and is disposed in an axial direction.

### BACKGROUND

The invention relates to a hydraulic tensioner for traction means of internal combustion engines, especially according to the preamble of claim 1.

Traction means, such as chain or belt drives, require optimal pre-tensioning for achieving maximum efficiency and service life. Because the length of the traction means changes due to heating and wear, its pre-tensioning must be readjusted continuously. Above all, hydraulic tensioners are suitable for this purpose.

Such a tensioner has a tensioner piston, which is guided with sealing play, e.g., in a pocket hole of a housing and which seals a compression chamber. In this chamber there is a compression spring, by means of which the tensioner piston is brought into pressure contact with a traction-means guiding component. When the tensioner piston is adjusted, additional oil is brought into the compression chamber via a valve of the housing. In this way and by means of the restoring spring, the tensioner piston is supported and can move in the direction of the traction means.

If a traction-means drive runs at a resonance rotational speed, this produces increased loading on the traction means. This leads, in turn, to pressure increases in the compression chamber, which, under some circumstances, produces an overload on the traction means. To prevent this overload, a pressure relief valve is required.

A known hydraulic tensioner for traction means of internal combustion engines has a tensioner piston, in whose piston bottom there is an axial central bore provided with an opening for an externally opening pressure relief valve, which is secured by a pot-shaped cap that is supported on and frictionally engages the piston bottom and that is in pressure contact with a tensioning means.

A disadvantage in the known hydraulic tensioner is the processing expense for its pot-shaped cap, which is manufactured in a metal-cutting process. This cap is positioned in a press fit in the piston bottom of the tensioner. Therefore, its outer diameters and also the inner diameters of the associated bore of the piston bottom must be machined specific to the fit. In addition, the outflow opening can be manufactured only with difficulty due to its processing direction.

### SUMMARY

Therefore, the invention is based on the objective of creating a hydraulic tensioner with a tensioner piston, which is distinguished by economical production and simple handling.

This objective is met according to the invention with the features of the independent claim 1.

Due to the small wall thickness of the sleeve according to the invention, the sleeve is easily deformable. To achieve the interference fit necessary for securing the pressure relief valve, the sleeve requires a relative large overlap and a resulting large deformation. This allows relatively coarse tolerance dimensions of the relevant surfaces and allows their machining to be eliminated. Therefore, the manufacturing expense relative to the state of the art is reduced significantly.

Because the sleeve is attached to the outer periphery of the reduced end of the piston bottom, they can be pulled off and pushed on again, e.g., with simple means for adjusting the pressure relief valve.

Because the opening, which is used for the discharge of the oil gradually cut off by the pressure relief valve from the axial central bore, is arranged in the sleeve base and in an axial arrangement, it can be introduced into the sleeve base in a simple way during the production of the sleeve.

This offers considerable production advantages, because the sleeve is manufactured with the sleeve base through non-cutting shaping techniques, preferably through deep drawing.

For the durability of the sleeve, it is advantageous if this sleeve is produced from sheet steel.

The overlap required for the interference fit of the sleeve on the reduced end of the piston bottom is achieved in that the sleeve features a reduction in its diameter in a region of its open end before installation at least in some regions of its periphery. This can be realized by drawing in the entire periphery or, e.g., by impressing a polygonal outline on the sleeve or by point-wise indenting of its periphery.

If the outer periphery of the reduced end of the piston bottom has a radial groove, then the sleeve can lock with its reduced-diameter parts into this radial groove and can therefore create a positive-fit axial securing of the sleeve. Any axial play in the sleeve is not critical, because this sleeve is brought into pressure contact with the end face of the piston bottom during operation.

Because the opening is stamped into the sleeve base, it can have any cross-sectional shape in addition to a circle.

For the discharge of the oil gradually cut off by the pressure relief valve, it is useful that the sleeve base has at least two openings, which are connected in terms of flow to the edge region of the axial central bore and which are offset relative to their axes by preferably 90°. In this way, an opening or, for partially covered openings, a cross section of these openings can be made available when the sleeve contacts a sliding rail of a traction-means drive in each rotational angle position of the tensioner piston.

If the axial ventilation openings cannot be placed far enough from each other, so that both remain closed when contacting a sliding rail, then by lowering the axial central bore, its effective diameter relative to the arrangement of the openings can be increased. In addition, grooves formed in the outer surface of the sleeve base can be provided, through which the oil can also be discharged under a sliding rail.

If the sliding rail has a central groove, then the opening can be formed in the center of the sleeve base, without running the risk of becoming covered.

Because the sleeve base rests on an end face of the piston bottom and is supported in this way, the wall thickness of the sleeve bottom can be equal to the small wall thickness of the sleeve. Therefore, the length of the tensioner is minimized.

One advantage of non-cutting shaping of the sleeve lies in that the sleeve base, which normally has a flat construction, can have a crowned construction without additional expense, which offers advantages in special installation cases. Because the wall thickness of the crowned sleeve base is also constant, it is advantageous, for its support, for the end face of the piston bottom to have a similar crowned construction. The processing quality of the crowned end surface is not critical, because it is covered by the groove-free deep-drawn sleeve base.

Pushing the sleeve onto the reduced end of the piston bottom is made easier by an internal bevel on its open end.

### BRIEF DESCRIPTION OF THE DRAWINGS

Additional features of the invention emerge from the following description and the drawings, in which an embodiment of the invention is shown schematically.

Shown are:

FIG. 1 a longitudinal cross-sectional view through a hydraulic tensioner and its tensioner piston with a sleeve according to the invention;

FIG. 2 a perspective partial view of the tensioner piston with the sleeve of FIG. 1.

### DETAILED DESCRIPTION OF THE PREFERRED EMBODIMENTS

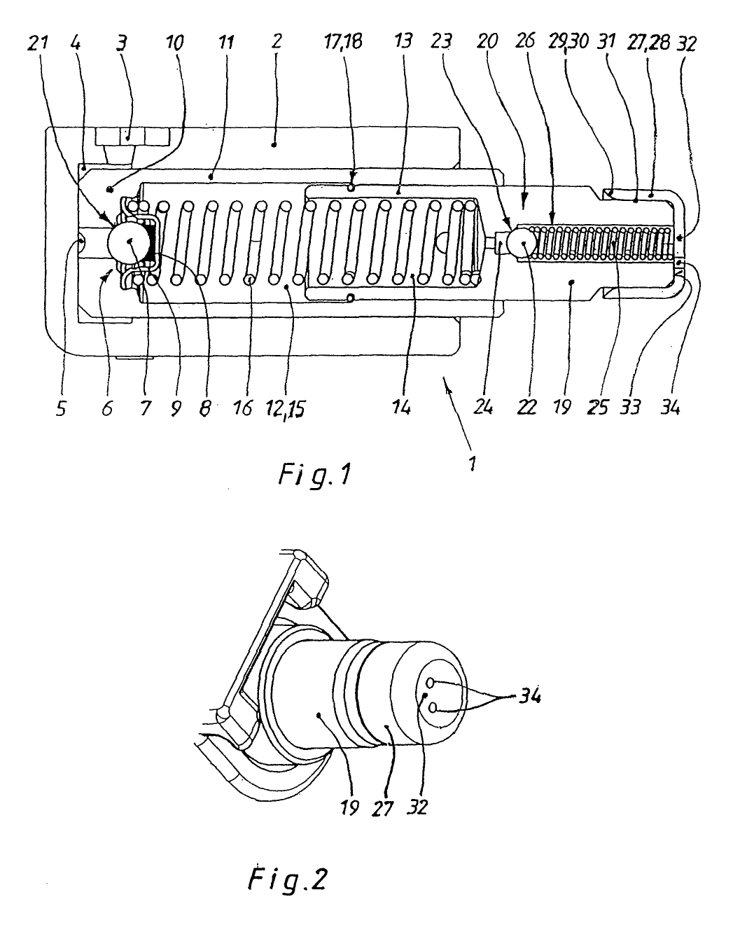

In FIG. 1, a longitudinal cross-sectional view through a hydraulic tensioner 1 with a receptacle housing 2 is shown. The receptacle housing 2 is connected rigidly to a not-shown crankcase. It has a compressed-oil connection 3, from which the lubricating oil is led via an annular space 4 and a cross groove 5 to a valve 6. This valve is located in the base 10 of a bushing 11, which is arranged with sealing play in the receptacle housing 2. The valve 6 has a valve ball 7 with a valve seat 21 and a valve spring 8, and also a valve cap 9.

The bushing 11 has a pocket hole 12, in which a tensioner piston 13 is guided with sealing play. This piston has a pocket hole 14. The pocket holes 12, 14 enclose a high-pressure chamber 15, in which a compression spring 16 is arranged. This spring applies a force via a tensioner piston 13 on a not-shown tensioning means and a corresponding traction means. The stroke of the tensioner piston 13 is limited by its retaining ring 17 in connection with a stop shoulder 18 of the bushing 11.

The tensioner piston 13 has a piston bottom 19, in which a pressure relief valve 20 is arranged. This valve has a valve ball 22 with a valve seat 23 and a gradual cut-off bore 24, and also a valve spring 25. The valve spring 25 and the valve ball 22, which are arranged in an axial central bore 26, are secured against falling out by a sleeve 27 according to the invention.

The sleeve 27 has a cylindrical part 28, whose open end 29 has an internal bevel 30, which makes pushing the sleeve 27 onto the reduced end 31 of the piston bottom 19 easier. In addition, the open end 29 is drawn in, in order to achieve an interference fit of the sleeve 27 on the reduced end 31. Because the sleeve 27 is attached to the outer periphery of the reduced end 31, it can be pulled off and replaced with simple means.

The sleeve 27 has a flat sleeve base 32, which rests with a close fit on the end face 33 of the tensioner piston 13 and therefore is supported.

In the sleeve base 32, one of the two openings 34 is shown, which are arranged in the edge region of the axial central bore 26 and through which the gradually cut off oil of the pressure relief valve 20 is discharged.

FIG. 2 shows in a perspective view the sleeve 27 pushed onto the piston bottom 19 with two openings 34. These openings are arranged in the cross-sectional region of the axial central bore 26 and offset by ca. 90° relative to the axis of the hydraulic tensioner 1. Therefore, it is achieved that when the sleeve base 32 contacts an additional tensioning means, e.g., a sliding rail, one of the openings 34 is always open. The force exerted by a sliding rail on the sleeve base 32 is simultaneously used for fixing the sleeve 27 in the axial direction.

### REFERENCE NUMBERS

1 Hydraulic tensioner
2 Receptacle housing
3 Compressed-oil connection
4 Annular space
5 Cross groove
6 Suction valve
7 Valve ball
8 Valve spring
9 Valve cap
10 Base
11 Bushing
12 Pocket hole
13 Tensioner piston
14 Pocket hole
15 High-pressure chamber
16 Compression spring
17 Retaining ring
18 Shoulder
19 Piston bottom
20 Pressure relief valve
21 Valve seat
22 Valve ball
23 Valve seat
24 Gradual cut-off bore
25 Pressure valve spring
26 Axial central bore
27 Sleeve
28 Cylindrical part
29 Open end
30 Internal bevel
31 Reduced end of piston bottom
32 Sleeve base
33 End face
34 Opening

1. Hydraulic tensioner for traction means for internal combustion engines, comprising a tensioner piston, a piston bottom in which there is an externally opening pressure relief valve in an axial central bore, which has an opening and which is secured by a pot-shaped cap, which is supported on and frictionally engages the piston bottom, the pot-shaped cap comprises a thin-walled sleeve with a sleeve base and is connected to an outer periphery of a reduced end of the piston bottom by an interference fit and a ventilation opening is axially arranged in the sleeve base.

2. Hydraulic tensioner according to claim 1, wherein the sleeve with the sleeve base is a deep drawn part.

3. Hydraulic tensioner according to claim 2, wherein the sleeve is manufactured from sheet steel.

4. Hydraulic tensioner according to claim 3, wherein the sleeve has a reduced diameter in a region of an open end thereof before installation at least in some regions of a periphery thereof.

5. Hydraulic tensioner according to claim 4, wherein the opening can have an arbitrary cross section or a circular shape.

6. Hydraulic tensioner according to claim 5, wherein the sleeve base has at least two openings, which are connected in terms of flow to an edge region of the axial central bore and which are offset by 90° in terms of their axes.

7. Hydraulic tensioner according to claim 6, wherein an outer surface of the sleeve base has engraved beads.

8. Hydraulic tensioner according to claim 7, wherein the sleeve base rests on an end face of the piston bottom.

9. Hydraulic tensioner according to claim 8, wherein the end face of the piston bottom and the sleeve base have a flat construction.

10. Hydraulic tensioner according to claim 9, wherein the sleeve has an internal bevel on the open end thereof.
